(19) United States
(12) Patent Application Publication
(10) Pub. No.: US 2009/0300937 A1
(43) Pub. Date: Dec. 10, 2009

(54) Indirect drying method using two temperature zones

(75) Inventors: Douglas W. J. Grünwald, Andover, NJ (US); Kerry J. Kovacs, Morristown, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Komline-Sanderson Engineering Corporation, Peapack, NJ (US)

(21) Appl. No.: 12/455,145

(22) Filed: May 28, 2009

Related U.S. Application Data
(60) Provisional application No. 61/130,462, filed on May 30, 2008.

(51) Int. Cl. F26B 7/00

(52) U.S. Cl. 34/424

(57) ABSTRACT

A method of drying material uses two different temperature zones within a single chamber. The material enters the first temperature zone where it is indirectly heated by structures heated to a first temperature. The material then moves to the second temperature zone where it is indirectly heated by structures heated to a second temperature different from the first temperature. The second temperature may be greater than or less than the first temperature. The method is particularly useful for drying materials that have a tendency to foul the heated structures of a dryer, such as wastewater treatment sludges.

### REFERENCE TO RELATED APPLICATIONS

This application claims the benefit of the filing date of U.S. Provisional Patent Application No. 61/130,462 filed May 30, 2008, the disclosure of which is hereby incorporated herein by reference.

### FIELD OF THE INVENTION

The present invention relates to the drying of materials by indirect heating, and more particularly through the use of a dryer having two temperature zones. Still more particularly, the present invention relates to the drying of materials, such as wastewater treatment sludges, having a tendency to foul dryer components during conventional drying processes.

### BACKGROUND OF THE INVENTION

Commercial, industrial, and residential establishments create wastewater. Wastewater contains objectionable contaminants, and must therefore be treated before it can be returned to the environment or used in other applications. Wastewater treatment is the process of removing contaminants from water and typically employs a series of physical, chemical, and/or biological processes.

The treatment of municipal wastewater is generally carried out in stages, often referred to as primary, secondary, and tertiary stages. The primary stage typically refers to the removal of suspended solids from the wastewater by various mechanical methods. Common methods of primary treatment include screening, gravity settling, and flotation. Primary treatment may also include the use of chemicals which, when added to the water, may precipitate or coagulate solids for removal by the foregoing mechanical methods. The solids and other contaminants that are removed from the wastewater during the primary stage, and their attendant water, are referred to as “primary sludge”.

The secondary stage of wastewater treatment removes additional contaminants from the water using various biological processes. These processes generally involve the addition of air and agitation to the wastewater to create an environment favorable to certain microorganisms in the water. These microorganisms consume certain contaminants in the water, causing the population of microorganisms to grow. The microorganisms may then be separated from the water using a variety of techniques including gravity settling, flotation, and membrane filtration. These biological solids removed from the wastewater during the secondary stage, and their attendant water, are often referred to as “secondary sludge”.

Some wastewater treatment plants eliminate the primary stage of treatment, sending the wastewater directly to the secondary processing stage. In such cases, the wastewater is typically sent through a grinder or other apparatus to comminute the solids therein prior to the secondary processing.

Municipal wastewater treatment plants may or may not subject their primary and/or secondary sludges to stabilization processes to reduce the amount of volatile components and disease causing microorganisms, or pathogens, present therein. Stabilization may result from aerobic or anaerobic biological processes or from chemical processes. One skilled in the art would understand how to apply these stabilization processes to achieve a desired degree of stabilization of a particular sludge.

The wastewater from industrial manufacturing processes also typically goes through one or more treatment processes to remove a large amount of the contaminants therein before the wastewater enters the municipal sewage system or waterways. These treatment processes may include the primary and/or secondary processes described above to produce primary and/or secondary sludges. Generally, however, industrial sludges are not subjected to the stabilization processes described above in connection with municipal sludges.

Both municipal and industrial sludges consist of liquid and solid materials. These solid and liquid materials may consist of both organic and inorganic matter, and may include hazardous materials, including pathogens, heavy metals, and hazardous organics. It is desirable to treat such sludges to form dry stable products that reduce disposal costs and/or allow for beneficial reuse.

There are a number of known methods of treating municipal and industrial wastewater sludges to reduce the water content thereof. The water content of such sludge consists of free water, capillary water, colloidal water, and intracellular water. Free, capillary, and colloidal water can generally be separated from the solids by gravity and by mechanical means such as gravity thickeners, centrifuges, belt presses, filters, etc., to increase the total solids up to about 15-60%. Intracellular water, however, must generally be removed by thermal drying, yielding a product having about 90% or more total solids.

Two major types of thermal drying are known in the treatment of wastewater sludge. The first type of drying, known as direct drying, brings heated air into direct contact with the sludge in a chamber. As the heated air mixes with the sludge, the water in the sludge is vaporized.

Another type of thermal drying uses an indirect process in which the sludge contacts a heated surface. The heated surface is usually composed of metal, heated by a heating medium such as steam or a thermal fluid. When the sludge contacts the heated surface, the heat vaporizes the water contained in the sludge. As direct contact between the heating medium and the sludge is avoided, the heating medium remains clean and uncontaminated.

One problem with drying sludge using an indirect heating process is fouling of the heat transfer surfaces of the dryer. The initial stages of the indirect drying process include heating the sludge to the boiling point of the liquid component to vaporize same. During this step of the process, certain materials within the sludge may gel, carmelize, or become sticky, and have a tendency to adhere to or scorch onto the heat transfer surfaces of the dryer. This scorched or adhered material creates an insulating film barrier to heat conduction between the heat transfer surfaces of the dryer and the sludge. This phenomenon is known as fouling. Such fouling can be cyclical, where the film barrier eventually peels away, shears off, or erodes from the heat transfer surface on its own, only to be built up again. Where fouling is cyclical, the drying process can reach a state of equilibrium and a sustainable drying rate can be achieved. More problematic, however, is the occurrence of progressive fouling.

Progressive fouling occurs when the film barrier covering the heat transfer surfaces of the dryer continues to grow over time. Eventually, the film reaches a thickness at which there is little heat transfer between such surfaces and the unadhered sludge, such that drying of the sludge is significantly diminished. When progressive fouling occurs, it becomes necessary to shut down the dryer from time to time and clean the deposited materials from the heat transfer surfaces therein. This down time is costly and inefficient.

With certain sludges, experience has shown that when the temperature of the heat transfer surface is lower, progressive fouling can be reduced or eliminated. It is known in the art to dry the sludge in two different indirect dryers operating in series. The first dryer is often configured with pushers or scrapers to convey the pasty sludge. This in turn removes the film that builds up on the heated surfaces, thereby reducing or eliminating the problem of progressive fouling. The use of two dryers, however, requires additional equipment and creates operating complexities. As a result of their cost and complexities, such systems are disfavored.

Another known method to reduce progressive fouling is to pre-condition the sludge before it is fed into the dryer. This may be accomplished by blending the wet sludge with previously dried sludge. Such technique decreases the moisture content of the blended sludge, thereby reducing or eliminating progressive fouling. However, this approach has obvious operational complexities, increased safety risk, requires more equipment, and may result in an increase in equipment size because the blended sludge has a lower heat transfer coefficient than the wet sludge.

In view of the problems noted above, there exists a need for improved methods of drying wastewater treatment sludges and other materials having a tendency to foul the apparatus used in the drying process.

### SUMMARY OF THE INVENTION

The present invention addresses this need.

The present invention provides methods of drying a material through the use of indirect heating, the material having a tendency to foul components of a dryer. The methods employ a dryer having a chamber and structures providing heat exchange with the material. One method in accordance with the present invention includes introducing the material to be dried into the chamber and moving the material through a first zone of the chamber in which a first portion of the structures is heated to a first temperature. The material is further moved through a second zone of the chamber in which a second portion of the structures is heated to a second temperature different from the first temperature. The material is then discharged from the chamber. Preferably, the method is a continuous method in which new material is introduced to the chamber as dried material is discharged therefrom.

According to this method, the first temperature may be less than the second temperature. In such an embodiment, the first temperature may be between about 220° F. and about 350° F. Preferably, the first temperature may be between about 240° F. and about 300° F. The second temperature may be between about 300° F. and about 450° F., and more preferably, the second temperature may be between about 350° F. and 400° F.

Alternatively, the first temperature may be greater than the second temperature. In such an embodiment, the first temperature may be between about 300° F. and about 450° F., and more preferably between about 350° F. and about 400° F. The second temperature may be between about 220° F. and about 350° F. Preferably, the second temperature may be between about 240° F. and about 300° F.

In preferred embodiments, the method may be used to dry a wastewater treatment sludge. The sludge may include primary solids, secondary solids, or a mixture of primary and secondary solids, all or some of which may be stabilized, or not stabilized to a sufficient degree to significantly reduce or eliminate progressive fouling.

In variants of this method, the dryer may include a housing defining a chamber and one or more rotating shafts disposed within the chamber. The rotating shaft or shafts may have elements extending therefrom to facilitate movement of the material within the chamber. The rotation of the shaft or shafts may mix the material as it is moved within the chamber. The elements extending from the rotating shaft or shafts may be heated, thereby providing heat transfer to the material within the chamber. Alternatively, or in addition, the housing may be heated to provide heat transfer to the material within the chamber. In a variant of these methods, the housing itself may be rotatable.

Another method according to the present invention may be used to dry wastewater treatment sludge. The method includes introducing the sludge into a dryer having a chamber and rotating surfaces disposed within the chamber. The chamber has a first zone in which a first portion of the rotating surfaces are heated to a first temperature, and a second zone in which a second portion of the rotating surfaces are heated to a second temperature different from the first temperature. The method further includes movement of the sludge through the first zone while agitating the sludge with the rotating surfaces to promote heat transfer between the first portion of the rotating surfaces and the sludge. The sludge is then moved through the second zone while agitating the sludge to promote heat transfer between the second portion of the rotating surfaces and the sludge. Thereafter, the sludge is discharged from the chamber.

In embodiments of this method, the sludge may include primary solids, secondary solids, or a mixture of primary and secondary solids, all or some of which may be stabilized, or not stabilized to a sufficient degree to significantly reduce or eliminate progressive fouling. In particular embodiments hereof, the sludge may be municipal wastewater treatment sludge.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1 is a block diagram of an indirect heating method using two temperature zones according to the present invention;

FIG. 2 is a plan view of a dryer for use in carrying out the method of the present invention, with the top removed to reveal the internal components thereof and the drive motor not shown for simplicity;

FIG. 3 is a highly schematic cross-sectional view of the rotating elements of the dryer shown in FIG. 2; and

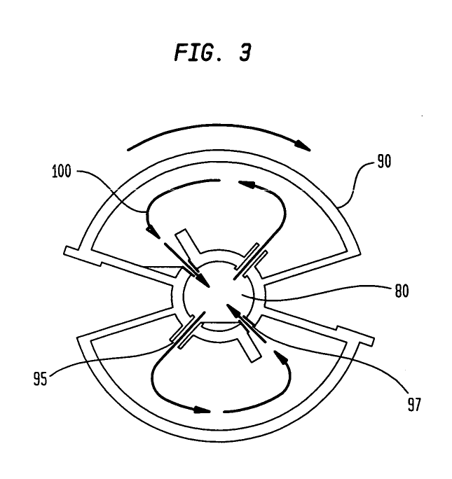

FIG. 4 is a highly schematic side elevational view of the dryer of FIG. 2 having a portion cut away to show the components within the chamber.

### DETAILED DESCRIPTION

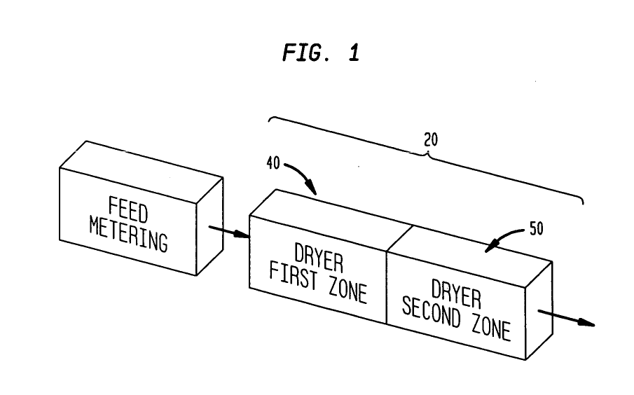

Referring now to the drawings, wherein like reference numerals indicate similar features, there is shown in FIG. 1 a diagrammatic overview of one possible method according to the present invention. According to the method, a sludge or other wet material may be fed through a metering device 10 into a dryer 20. Upon entering dryer 20, the material is input to a first temperature zone 40 having internal structures heated to a first temperature. After conveyance through the first temperature zone 40, the material enters a second temperature zone 50 having internal structures heated to a second temperature different from the first temperature. As it leaves the second temperature zone 50, the material may be discharged from dryer 20 for further handling.

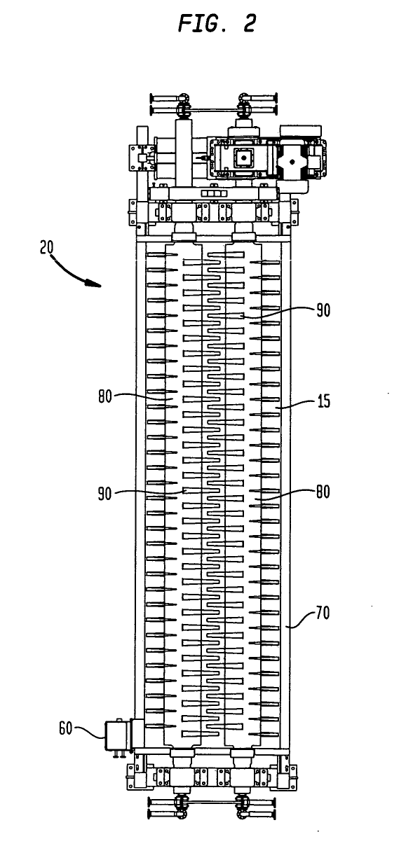

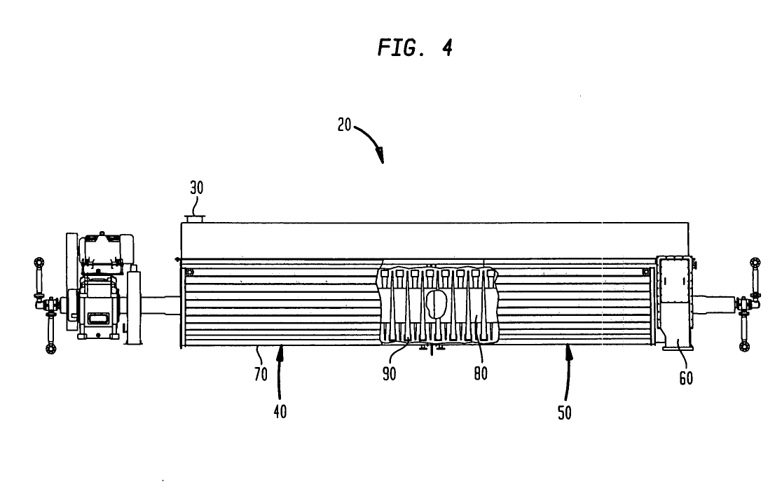

Preferred methods according to the present invention may use any type of dual zone indirect heating apparatus, including those that are known in the art for use in continuous manufacturing processes requiring multiple temperature zones. One such apparatus is the K-S Paddle Dryer available from Komline-Sanderson Engineering Corporation of Peapack, N.J., USA. As shown in FIGS. 2 and 4, such devices generally have a housing 70 defining an internal chamber 15. A pair of rotating shafts 80 is disposed within chamber 15. Rotating shafts 80 may include heated elements for transferring heat to the material in chamber 15 and for moving the material in the length direction of the chamber. In this regard, rotating shafts 80 may have protrusions 90 extending therefrom for moving the material within chamber 15. Protrusions 90 include tabs attached to the trailing ends thereof configured to move the material being processed away from the walls of housing 70. Although dryer 20 is shown in FIG. 2 with two rotating shafts 80, it is to be understood that dryer 20 may be provided with a single rotating shaft or with more than two rotating shafts disposed within chamber 15.

To practice the methods of the present invention, dryer 20 has two distinct temperature zones 40 and 50 within chamber 15. These temperature zones may be provided by heating protrusions 90, attached to rotating shafts 80, by introducing a heated medium 100, such as steam or a thermal fluid, into a hollow portion within each protrusion. Any known thermal fluids may be used as heating medium 100, including oil, water, glycol, or other fluids. The heating medium 100 may be supplied to protrusions 90 by a supply conduit (not shown) within shaft 80, and individual feeder conduits 95 from the supply conduit to each protrusion. In a similar fashion, after the heating medium 100 has circulated within protrusions 90, it may travel through individual feeder conduits 97 to a return conduit (not shown) within shaft 80. While the heating medium 100 is circulating within protrusions 90, channelized flow patterns might be used to produce high liquid velocities resulting in a uniform temperature distribution and high heat transfer coefficients. Alternatively, the protrusions 90 may be solid, with the heating medium 100 circulating through the shaft 80 and the protrusions 90 being heated by conduction from the shaft.

The two distinct temperature zones 40 and 50 may be achieved in chamber 15 by employing two separate supply and return conduits for the heating medium 100. A first supply conduit may enter shaft 80 at one end of dryer 20, and supply a heating medium 100 at a first temperature to the protrusions 90 along a predetermined length of the shaft. A first return conduit may then conduct this heating medium out from the same end of shaft 80. A second supply conduit may enter shaft 80 at the opposite end of dryer 20, and supply a heating medium 100 at a second temperature different from the first temperature to the protrusions 90 along another length of the shaft. This heating medium may be removed through this end of shaft 80 using a second return conduit.

Housing 70 may also be heated in a similar fashion to provide heat transfer to the material within chamber 15. In this regard, housing 70 may be divided into two separately heated portions, with the portion in temperature zone 40 being heated to about the temperature of the protrusions 90 in temperature zone 40 described above, and the portion in temperature zone 50 being heated to about the temperature of the protrusions 90 in temperature zone 50 described above. Alternatively, housing 70 may be heated to the lower of the two temperatures and simply serve to supply additional thermal energy to the material within chamber 15.

According to the methods of the present invention, dryer 20 is used for drying materials that have a tendency to foul shafts 80, protrusions 90, and housing 70 during the drying process. One such material is the sludge that results from the treatment of municipal wastewater. Such sludges may include primary solids, secondary solids, or a mixture of primary and secondary solids, all or some of which may be stabilized, or not stabilized to a sufficient degree to significantly reduce or eliminate progressive fouling.

In the methods of the present invention used to dry such municipal wastewater sludges, the sludge is input in a continuous fashion to chamber 15 of dryer 20 through inlet 30. Once in chamber 15, the sludge is processed in temperature zones 40 and 50. Temperature zone 40 is preferably at a lower temperature than temperature zone 50. In that regard, temperature zone 40 is preferably at a temperature of between about 220° F. and about 350° F., and more preferably between about 240° F. and about 300° F. The processing in temperature zone 40 preferably proceeds until a large portion of the moisture in the sludge is vaporized, leaving a material having a moisture content of between about 40 wt % and about 70 wt %. As it leaves temperature zone 40, the material enters temperature zone 50 where the drying process continues. Temperature zone 50 is preferably at a temperature of between about 300° F. and about 450° F., and more preferably between about 350° F. and about 400° F. After processing in temperature zone 50, the material is sufficiently dried for further handling or processing. A moisture content of about 10 wt % or less may be achieved. This material may then be output from chamber 15 through outlet 60.

Without wishing to be held to any particular theory, it is believed that the methods of the present invention eliminate, or at least minimize, the progressive fouling of shafts 80, protrusions 90, and the inside surface of housing 70 because the surface temperature of these components in temperature zone 40, where many reactions within the sludge are beginning to occur, is less than the temperature ordinarily used in these drying processes. High temperatures at this stage may contribute to the gelling of starches, carmelizing of sugars, melting of plastic particulate, and denaturing of proteins, any one or more of which materials may be present in the sludge. Any one of these occurrences, and others, can cause the formation of a fouling film. Using a lower temperature during the initial stages of drying, however, may reduce the rate of these occurrences, thereby allowing the materials to bind onto each other, rather than the internal surfaces of the dryer. By the time the sludge enters temperature zone 50, it has become sufficiently viscous to induce cyclic fouling which results in an acceptable steady-state condition. At this point, the progressive fouling tendency of the sludge has been greatly reduced by the treatment of the sludge in temperature zone 40. The ability to have a second temperature zone at an elevated temperature permits the overall drying process to be performed in an acceptable amount of time and space, thereby obviating the need for excessively large machinery and the issues such machinery present.

Although the method described above employs a first temperature zone 40 having a lower temperature than that in the second temperature zone 50, that need not be the case. That is, temperature zone 50 may have a lower temperature than temperature zone 40. Such an arrangement may provide a measure of safety in a sludge drying process by reducing the risk of fire. Because sludge is comprised at least partially of organic components, subjecting dried sludge at the end of a process to high levels of heat may cause the sludge to ignite. By lowering the temperature at the end of the process the risk of fire may be reduced or eliminated.

Alternatively, this arrangement may be advantageous where, in contrast to the process described above, the end product of a material to be dried is heat sensitive. For example, in such a case it may be advantageous to first submit the material to a higher temperature to evaporate any surface moisture. Thereafter, the material may be submitted to a lower temperature due to the heat sensitive nature of the end product. By way of example, such a heat sensitive product may include certain polymers. In such an embodiment, first temperature zone 40 may be between about 300° F. and about 450° F., and preferably between about 350° F. and about 400° F. The second temperature zone 50 may be between about 220° F. and about 350° F., and preferably between about 240° F. and about 300° F. Furthermore, although the diagram in FIG. 1 shows first temperature zone 40 and second temperature zone 50 to be about equal in size, it is to be understood that the size of each temperature zone relative to the other does not need to be equal, but rather can vary depending on the material being dried.

Variants of the method described above are also contemplated herein. In one such variant, rather than using rotating shafts 80 and protrusions 90 to tumble and heat the material being dried, housing 70 may itself rotate. In such an embodiment, the rotating housing contacts and moves the material to promote heat transfer between the heated surfaces of the housing and the material. In addition, there may be a shaft disposed within the rotating housing which may or may not be heated, and which may be stationary or may rotate simultaneously with the housing. Where there is a shaft, the shaft may include protrusions similar to protrusions 90 discussed above.

Additional variants of the above described method are also contemplated by the present invention. In one variant, other structures may be attached to the shaft 80 in place of protrusions 90. These alternate structures may include screw flights, ribbon blades, scraping tabs, lifting tabs, wedges, plows, paddles, rods, tubes, discs, and/or segments of a disc. Such structures may be solid or hollow, or a combination of solid and hollow, and may be heated in the same manner as protrusions 90.

While the method of the present invention has been described above in connection with the drying of municipal wastewater treatment sludges, the method also may be used to treat other materials having a tendency to foul the components of the dryer. These materials include, for example, wastewater sludges produced as a byproduct of industrial processes. Such sludges include those having a high sugar content, such as results from the processing of fruits and vegetables; sludges having a high starch content, such as results from the processing of tubers and grain; and sludges having a high protein content, such as results from the processing of eggs, fish, and meat.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

1. A method of drying material through the use of indirect heating, the material having a tendency to foul components of a dryer, the dryer having a chamber and structures providing heat exchange with the material, the method comprising:
introducing the material to be dried into an inlet of the chamber;
conveying the material through a first zone of the chamber in which the structures are heated to a first temperature;
conveying the material through a second zone of the chamber in which the structures are heated to a second temperature different from the first temperature; and
discharging the material through an outlet of the chamber.

2. The method of claim 1, wherein the first temperature is less than the second temperature.

3. The method of claim 2, wherein the first temperature is between about 220° F. and about 350° F.

4. The method of claim 3, wherein the first temperature is between about 240° F. and about 300° F.

5. The method of claim 2, wherein the second temperature is between about 300° F. and about 450° F.

6. The method of claim 5, wherein the second temperature is between about 350° F. and about 400° F.

7. The method of claim 1, wherein the first temperature is greater than the second temperature.

8. The method of claim 7, wherein the first temperature is between about 300° F. and about 450° F.

9. The method of claim 8, wherein the first temperature is between about 350° F. and about 400° F.

10. The method of claim 7, wherein the second temperature is between about 220° F. and about 350° F.

11. The method of claim 10, wherein the second temperature is between about 240° F. and about 300° F.

12. The method of claim 1, wherein the material is a wastewater treatment sludge.

13. The method of claim 12, wherein the sludge includes unstabilized solids.

14. The method of claim 12, wherein the sludge includes primary solids.

15. The method of claim 12, wherein the sludge includes a mixture of primary solids and secondary solids.

16. The method of claim 1, wherein the dryer includes a rotating shaft disposed in the chamber.

17. The method of claim 1, wherein the dryer includes a plurality of rotating shafts disposed in the chamber.

18. The method of claim 16, wherein the rotating shaft has protrusions extending therefrom to facilitate movement of the material within the chamber.

19. The method of claim 18, wherein the protrusions are heated, thereby providing heat transfer to the material within the chamber.

20. The method of claim 1, wherein the chamber is rotatable.

21. The method of claim 20, wherein the chamber is heated, thereby providing heat transfer to the material within the chamber.

22. A method of drying wastewater treatment sludge, the method comprising:
introducing the sludge into an inlet of a dryer having a chamber and at least one rotating shaft disposed in the chamber, the rotating shaft including protrusions extending therefrom, the chamber having a first zone in which the at least one rotating shaft is heated to a first temperature, and a second zone in which the at least one rotating shaft is heated to a second temperature different from the first temperature;
moving the sludge through the first zone while agitating the sludge with the rotating shaft to promote heat transfer between the rotating shaft and the sludge;
moving the sludge through the second zone while agitating the sludge to promote heat transfer between the rotating shaft and the sludge; and
discharging the sludge through an outlet of the chamber.

23. The method of claim 22, wherein the sludge includes unstabilized solids.

24. The method of claim 22, wherein the sludge includes primary solids.

25. The method of claim 22, wherein the sludge includes a mixture of primary solids and secondary solids.

26. The method of claim 22, wherein the sludge is a municipal wastewater treatment sludge.
